(19) United States
(12) Patent Application Publication
(10) Pub. No.: US 2016/0023175 A1
(43) Pub. Date: Jan. 28, 2016

(54) System and Method for Analyzing Completion Fluids

(71) Applicant: Eric Herschap, Orange Grove, TX (US)

(72) Inventor: Eric Herschap, Orange Grove, TX (US)

(21) Appl. No.: 14/586,572

(22) Filed: Dec. 30, 2014

Related U.S. Application Data
(60) Provisional application No. 61/922,543, filed on Dec. 31, 2013.

(51) Int. Cl. B01F 15/00; B01F 3/08

(52) U.S. Cl. CPC B01F 15/00129; B01F 15/00331; B01F 15/00136; B01F 15/00175; B01F 3/088

(57) ABSTRACT

Disclosed herein is a real time method and system for analyzing and optimizing a composition of a completion fluid used in oil well operations. The system employs a plurality of sensors and monitors various parameters of the completion fluid, while also monitoring parameters of the oil well. This allows for information to be compared and the completion fluid is modified accordingly prior to the completion fluid being sent sub-terrain. The system includes a centralized command center that receives information from the sensors and translates this information to determine the appropriate ratio of chemicals that should be blended to form the completion fluid. The system allows an operator to monitor the completion fluid and the oil well operation in real time and also generates instant data analysis reports.

### CROSS REFERENCE TO RELATED APPLICATIONS

The present application claims priority to U.S. provisional patent application Ser. No. 61/922,543 filed on Dec. 31, 2013, which is incorporated herein by reference in its entirety.

### FIELD OF THE INVENTION

The present invention relates to a system and method for optimizing a composition of a completion fluid used in an oil well. More particularly, the present invention relates to a system that provides real time analysis of the completion fluid using a centralized data acquisition center.

### BACKGROUND OF THE INVENTION

The use of completion fluids for an oil well operation is very well documented. The completion fluids are used before the start of the drilling operation, in completing, recompleting, or reworking the oil well. A completion fluid is a solid-free liquid substance that completes the oil well. In other words, the bottom of the oil well is prepared to the required specifications before the oil well is ready for drilling. The purpose of completion fluid is to maintain control over the oil well, such that if the down-hole hardware fails, formation or completion parts of the drilling equipment are not damaged. Completion fluid systems are selected to optimize the oil well completion operation and are specific to the conditions of the oil well. The system selection depends on geological conditions of the borehole and varies with the geographical location of the oil well.

U.S. Pat. No. 4,444,668 by Michael Walker and Joe Johnson. Jr discloses a composition of completion fluid for use in oil wells that reduces the corrosion effect of the completion fluid on the ferrous metal tubing. However, the patented invention does not provide any real time analysis of the completion fluid as per the changing geological conditions in the oil well. Selecting an appropriate composition of the completion fluid is important and often critical for oil well operations. Using completion fluids which are not conducive with the bore well conditions can have a significant impact on various bore well parameters, and can delay a project not only during the completion operation and well production startup, but also throughout the oil well's production life.

As oil well drilling is becoming more and more complex, there is a need to maintain real time control over the entire process by analyzing the parameters of the geological site and accordingly controlling the properties of the completion fluids. Completion fluids play an important role in oil excavation processes and are a big part of what makes up an oil well. The completion fluid to be used should be of required density, flow, pH, and the like, and should be chemically compatible with reservoir formation of the well.

Various methods and systems have been employed for choosing the right combination and composition of chemicals that are to be used as completion fluids. The collection and analysis of the down hole data helps the onsite process engineers to control the process by making better production decisions, thereby optimizing the process. However, one of the current problems faced by onsite engineers is that there is a substantial time gap between the collection and analysis of the process data. For example, the data which is to be analyzed today must have been collected about a week or a month ago. Thus, analyzing previously collected data might not help in solving existing real time problems faced by onsite engineers.

Another problem associated with the existing methods is that the completion fluids are manually formulated in a mixing unit. This method is time consuming and results in various inaccuracies in the composition of the completion fluid.

Chinese Patent No. 1,970,991 by Chaodong Tan discloses a system and a method for optimizing and analyzing the working condition of an oil well. European Patent No. 1,397,579 by Stephen Rester discloses a wellbore evaluation method at a condition where the pressure induced by the weight of the drilling fluid (hydrostatic pressure) is less than the actual pressure within the pore spaces of the reservoir rock (formation pressure) often termed as “underbalanced” drilling. However, both the above mentioned references fail to disclose a real time completion fluid monitoring system, which is a pressing need in the industry at this time.

In light of the foregoing, there exists a need for a system and a method that improves the productivity of the oil excavation process and increases turn around rate for formulating the ideal completion fluid composition before the fluid is deposited in the oil well. It has become increasingly important to develop a system that uses real time data acquisition to extract information of the oil well and transform it in the form of signals to modify the completion fluids as required, in real-time.

### SUMMARY OF THE INVENTION

The present invention discloses a real time system and process of producing, analyzing and optimizing completion fluids used in oil wells, also referred to as well holes and bore well. The process and the system can be employed for straight, horizontal, or diagonal drilling of the oil well. A series of sensors present at an inlet of the well hole as well as inside the well hole sense various parameters associated with the well hole and transmit or relay the information to a command center. The command center analyzes the data received and assists in the formulation of the completion fluid by controlling a series of pumps. The series of pumps in turn control the supply of one or more chemicals used for the formation of the completion fluid. The chemicals are mixed in a desired ratio as calculated by the command center in a mixing tank to form the completion fluid. An object of the present invention is to provide a real time system for obtaining and analyzing data in real time, for optimizing the process of formation of the completion fluid used in the oil well. The system can be set up as a unit at the well site, or can be skid mounted for moving from one site to another site as desired.

The units disclosed herein have a centralized data acquisition system (DAS) that receives information from the series of sensors and utilizes this information to make adjustments to the composition of the completion fluid prior to charging the completion fluid down into the oil well. The centralized DAS allows an operator to see the effects of the completion fluid that is being sent sub-terrain on the oil well parameters. The real time application feature tied to the DAS allows the operator to effectively and productively monitor the process and generate real time job reports and charts at any given time and location. The system can be configured to operate from a computer, a tablet, a cell phone, a mobile device, or any portable electronic device capable of transmitting and receiving data.

Embodiments of the present invention provide a system having a first set of sensors, a second set of sensors, a transmitter, a command center and a series of pumps. The first and second sets of sensors sense parameters of the completion fluid and parameters associated with the oil well, respectively. The transmitter transmits the data sensed by the first and second sets of sensors to the command center in real time. The command center analyzes the data and determines a ratio of chemicals that are to be mixed for producing the completion fluid. The series of pumps control the passage of the chemicals to be mixed in a mixing tank to form the completion fluid. The operation of the series of pumps is controlled based on the ratio determined by the command center.

### BRIEF DESCRIPTION OF DRAWINGS

The invention is described in detail below with reference to the drawings and examples. Such discussion is for purposes of illustration only. Modifications within the spirit and scope of the present invention, set forth in the appended claims, will be readily apparent to one of skill in the art. Terminology used throughout the specification and claims herein is given its ordinary meaning except as more specifically defined:

FIG. 1 represents a schematic block diagram of a system for analyzing and optimizing a completion fluid that is to be sent in an oil well;

FIG. 2 represents a flowchart representing a method for analyzing and optimizing the completion fluid that is to be sent in the oil well;

FIG. 3 shows a log report of a process for analyzing and optimizing the completion fluid at various time intervals;

FIG. 4 shows a graphical representation of the rate of change of circulation pressure of the completion fluid, discharge rate of the completion fluid and well head pressure of the oil well with respect to time;

FIG. 5 shows a graphical representation of the rate of change of discharge rate of chemicals that form the completion fluid with respect to time;

FIG. 6 shows a graphical representation of the rate of change of volume of slick water, pressure of the discharge rate of the completion fluid, volume of a mixing tank and viscosity of the completion fluid with respect to time; and

FIG. 7 shows a graphical representation of the rate of change of pH of the completion fluid and total dissolved solids (TDS) in the mixing tank with respect to time.

### DETAILED DESCRIPTION OF THE INVENTION

As used in the specification and claims, the singular forms “a”, “an” and “the” include plural references unless the context clearly dictates otherwise. For example, the term “an article” may include a plurality of articles unless the context clearly dictates otherwise.

There may be additional components described in the foregoing application that are not depicted on one of the described drawings. In the event such a component is described, but not depicted in a drawing, the absence of such a drawing should not be considered as an omission of such design from the specification.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention is directed to using automation for collection of all relevant sensor and instrumentation data into a central database for the purpose of optimizing completion fluids to be sent into an oil well. The data is available for viewing, processing, correlation, storage and finding in one central location. One or more sensors, or information provider units can provide data to a centralized location (hereinafter ‘command center’) that can remotely communicate or locally make data available concerning all sensors for optimizing completion fluids. Optionally, data that is collected can also be used in a streamlined workflow by other systems and operators upon acquisition.

Included in the invention to allow collection of data and optimization of a completion fluid are the following: one or more processors, a memory unit coupled to the one or more processors, a computer readable media storage and retrieval device, and a graphic controller to control display of the information on a display unit. These devices are standard to the industry of monitoring and processing data and as such, any suitable device can be used with the present invention. The invention lies with the use of these known devices in a new manner to allow collection and processing of data for use with completion fluids at an oil well site, or a rig site as needed. Also, the monitoring can be done from a central command center or a portable electronic device allowing for receipt and transfer of information. In this manner, a user can be at, near or away from the oil well site and still monitor the activity of the oil well.

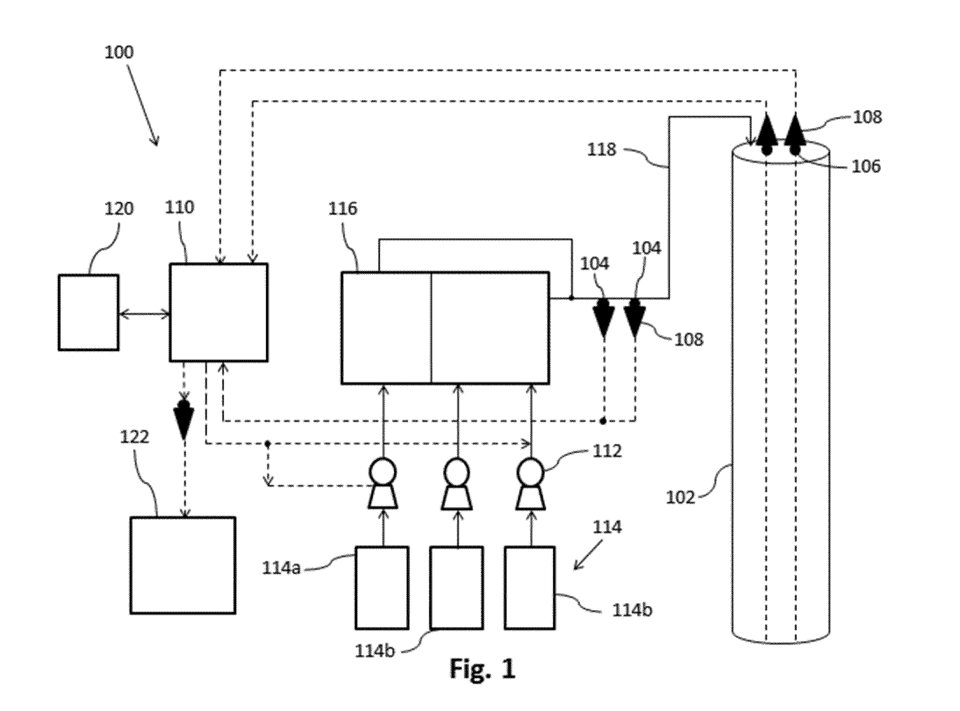

With reference to the attached figures, certain embodiments of the present invention include a system 100 as shown in FIG. 1. The system 100 is used to optimize a composition of the completion fluid that is to be sent sub-terrain. The system 100 includes an oil well 102, a first set of sensors 104, a second set of sensors 106, a plurality of transmitters 108, a command center 110, a plurality of pumps 112, a plurality of storage tanks 114, and a mixing tank 116. It should be appreciated that that the term oil well 102 can be interchangeably used with the terms bore well 102 and well hole 102 in the current disclosure. As used herein “plurality” means at least two, and as many as needed based on user desirability for monitoring of parameters.

The first set of sensors 104 sense various parameters of the completion fluid. The second set of sensors 106 sense various parameters associated with the oil well 102. In an embodiment of the present invention, the second set of sensors 106 are installed at an inlet of the oil well 102 i.e., at the surface of the oil well 102. However, it should be appreciated that the second set of sensors 106 can be placed at different locations of the well site, including the bottom of the oil well 102. The plurality of transmitters 108 transmits the above mentioned parameters to a command center 110. The command center 110 receives the parameters in the form of a first signal. The command center 110 is coupled to multiple communication networks working in conjunction with multiple servers (not shown).

For purposes of this disclosure, the command center 110 or an information handling system 110 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the command center 110 may be a personal computer, a network storage device, a tablet, a mobile phone or any other suitable device. The command center 110 may include a random access memory (RAM), a central processing unit (CPU), hardware or software control logic, ROM, and/or other types of nonvolatile memory, including transitory and non-transitory memories. The command center 110 may further include one or more disk drives, one or more network ports for communication with external devices as well as various input and output (I/O) devices, such as a keyboard, a mouse, a video display, one or more buses operable to transmit communications between the various hardware components.

The system 100 may transmit data via a network and radio frequency transceivers to remote locations. The network communication may be any combination of wired and wireless communication. In one example, at least a portion of the communication is transferred across the internet using TCP/IP internet protocol. In another embodiment, the network communication may be based on one or more communication protocols (e.g., Hypertext Transfer Protocol (HTTP), HTTP Secured (HTTPS), Application Data Interface (ADI), Well Information Transfer Standard Markup Language (WITSML), etc.). A particular non-volatile machine-readable medium may store data from one or more well sites and may be stored and retrieved based on various communication protocols. The non-volatile machine-readable media may include disparate data sources such as ADI, Java Application Data Interface, Well Information Transfer Standard Markup Language (WITSML), Log ASCII Standard (LAS), Log Information Standard (LIS), Digital Log Interchange Standard (DLIS), Well Information Transfer Standard (WITS), American Standard Code for Information Interchange (ASCII), Open Works, SiesWorks, Petrel, Engineers Data Model (EDM), Real Time Data (RTD), Profibus, Modbus, OLE Process Control (OPC), various RF wireless communication protocols (such as Code Division Multiple Access (CDMA), Global System for Mobile Communications (GSM), Video/Audio chat, etc. While the system 100 shown in FIG. 1 employs client-server architecture, embodiments are not limited to such architecture, and could equally well find application in a distributed or peer-to-peer or any other suitable architecture system.

It should be noted that the system 100 may also be hereinafter interchangeably referred to as the data acquisition system (DAS) 100. It should be appreciated that the DAS 100 may be present at a remote location from the oil well site. In another embodiment of the invention, the system 100 can be set up as a unit at the well site, or can be skid mounted for moving from one site to another. The data acquisition system 100 acquires a set of data using the first set of sensors 104 and the second set of sensors 106 in real time and the data is analyzed at the command center 110. The command center 110, based on the analysis of the data, influences the properties of the completion fluid by changing the composition of chemicals that are to be blended to form the completion fluid.

The completion fluid typically includes a mixture of various chemicals and liquids. The chemicals are stored in the plurality of storage tanks 114. The storage tanks 114 include a gel tank 114a and a slick water tank 114b as shown in FIG. 1, according to an embodiment of the present invention. The gel tank 114a contains a gel such as Guar or Xantham. The chemicals may also include pipe on pipe (POP) lubricant, friction reducer such as polyacrylamide. In another embodiment of the present invention, the chemicals may include chlorides, brine and fresh water. It should be appreciated that any other chemicals can be used that are conducive with the geological condition of the oil well 102. The storage tanks 114 are coupled with the pumps 112, flow rate meters (not shown) and a series of multi-port direct injection lines (not shown). Each unit of the system 100 that is capable of handling fluids or liquids such as the storage tanks 114, the mixing tank 116 and the like is equipped with a variable frequency drive (VFD) module to regulate the flow of the fluid. The series of multi-port direct injection lines suck and eject the amount of fluid calibrated by the VFD module. In the present embodiment, a Toshiba VFD module (Trademark of Toshiba) is used to regulate the fluid flow. The pumps 112 control the passage of the chemicals from the storage tanks 114 to the mixing tank 116. The chemicals of the completion fluid are blended together in the mixing tank 116 using dispersion blades (not shown) and then charged through a line 118 to the oil well 102. In the present embodiment, the mixing tank 116 has a fluid handling capacity ranging of about 35 bbl to 75 bbl. It should be appreciated that the size of the mixing tank 116 can vary based on individual user needs. The mixing tank 116 facilitates jet stimulation of the chemicals to ensure proper hydration and product utilization in minimum time. The operation of the pumps 112 is controlled by the command center 110. In the event of a hardware failure, the chemicals can be blended manually in the mixing tank 116. The plurality of pumps 112 can also be operated manually in case of such an event.

The first set of sensors 104 is configured to sense various parameters of the completion fluid coming out of the mixing tank 116. In an exemplary embodiment of the present invention, the first set of sensors 104 is provided at the inlet of the oil well 102. In another exemplary embodiment, the first set of sensors 104 capable of withstanding geological conditions of the oil well 102 may be provided at the bottom of the oil well 102 or at an inner sidewall of the oil well 102. The first set of sensors 104 senses the flow rate, drag, temperature, viscosity, and pH of the completion fluid. Each unit of the system 100 that is capable of handling fluids or liquids such as the storage tanks 114, mixing tank 116 and the like are equipped with a Brookfield model TT100 in-line viscometer (trade mark of Brookfield Engineering Laboratories) to measure process fluid viscosity in a fully flooded product stream. The Brookfield model TT100 in-line viscometer measures the viscosity under pressure or vacuum and is unaffected by changes in pressure, laminar flow or density. It should be appreciated that the use of any other viscometer and a fluid flow regulator is well within the scope of the invention. The first set of sensors 104 includes a set of micro-motion sensors, such as pH sensors, temperature sensor, and the like. Use of any other kind of sensors is well within the scope of the present invention. Individual sensors may be used for each parameter, or a multiuse sensor with the ability to monitor several parameters may be used.

The second set sensors 106 is configured to sense one or more parameters associated with the oil well 102, i.e., the change in operating conditions inside the oil well 102. In various embodiments of the present invention, one or more parameters associated with the oil well 102, are oil well head pressure, temperature and pressure inside the oil well, and porosity of the bed etc. The second set of sensors 106 also measure environmental parameters, directional drilling parameters, and formation evaluation parameters. Such parameters include down hole pressure, down hole temperature, the resistivity or conductivity of the drilling mud and earth formations, the density and porosity of the earth formations, as well as the orientation of the wellbore. While the second set of sensors 106 is normally present at the surface of the oil well 102; they may be appropriately placed outside the oil well 102, and may sense the parameters remotely. In another exemplary embodiment, the second set of sensors 106 capable of withstanding geological conditions of the oil well 102 may be present at the bottom of the oil well 102 or at the inner sidewall of the oil well 102. Examples of the second set of sensors 106 include, but are not limited to: a resistivity sensor, a nuclear porosity sensor, a nuclear density sensor, a magnetic resonance sensor, and a directional sensor package. In an embodiment, the sensors may be based on a standard hardware interface that could add new sensors for measuring new metrics at the well site in the system. In the present embodiment, the standard hardware interface is the command center 110.

There may be times when the surface of the well site needs to be monitored, tested and/or analyzed for consideration of composition of the completion fluids. Examples of surface parameters include rotary torque, rotary RPM, well depth, hook load, standpipe pressure, and any other parameter of interest. The present invention may be used for monitoring these conditions in addition to the oil well and the completion fluid parameters. The first and second sets of sensors (104 and 106) sense the aforementioned parameters and transmit the data to the command center 110 by way of the plurality of transmitter 108 in form of a first signal. For clarity, the first and the second set of sensors (104 and 106) shown in FIG. 1 are drawn such that the triangle portions represents the plurality transmitters 108, and the circular portion represents the sensor. The parameters may be transmitted digitally, by analog, or by other methods known in the art. The command center 110 upon receiving the parameters of the completion fluid and the oil well 102 sensed by the first and the second set of sensors (104 and 106) respectively, analyzes the parameters. The deviation in the parameters of the oil well 102 with respect to the ideal is identified and accordingly the command center 110 determines a percentage composition in which the chemicals required for the preparation of the completion fluid are to be blended. The percentage composition of the chemicals that are to be blended to form the completion fluid is hereinafter referred to as a first ratio of the chemicals that are to be blended to form the completion fluid. The command center 110 generates a second signal associated with the first ratio. The command center 110 also determines the injection rate of the completion fluid, along with the first ratio of chemicals for preparing optimized completion fluid. The command center 110 regulates the pumps 112 by sending the second signal to control the flow of chemicals to the mixing tank 116 so that the chemicals are blended in the determined first ratio. The completion fluid is formed in the mixing tank 116 and transferred to the oil well 102. The optimized completion fluid exits the mixing tank 116 through the line 118 and enters the oil well 102. A high pressure pump (not shown) is present on the line 118 that pumps the completion fluid to the oil well 102.

The blending of the chemicals occurs in the mixing tank 116, which is an open roof tank. An operator (or another user) can visually inspect or observe the mixing process before the completion fluid is charged into the oil well 102. The mixing tank 116 shown in FIG. 1 is divided into two sections, but can be divided into as many sections as needed or desired for producing the optimized completion fluid. For exemplary purposes, the tank is divided for holding gel on one side, and slick water (FR/POP) on the other side before formulation of the completion fluid. As an option, the mixing tank 116 can include a cover which may or may not be removable. The covering of the mixing tank 116 is based on user desirability.

The system 100 is controlled based on real time data and feedback from the first and second sets of sensors 104 and 106. Hence, the ratio of the chemicals in the completion fluid changes over time with respect to a response therefrom. A skilled artisan will understand that the system 100 can also account for horizontal, vertical or diagonal drilling and associate all the units and calculations thereto.

The command center 110 capable of collecting and storing data for optimization of the completion fluids can be used for other jobs, such as performing quality check of integrated data. Each unit of the system 100 that is communicatively coupled with an electronic device and a centralized data collection unit such as the command center 110 and the like uses Eagle X2 software (trade mark of Mobile Data Technologies). The Eagle X2 software monitors more than 6 sensors at a time. The user can view up to 3 real time graphs and control 12 sensors at a time on a single 21″ monitor using the Eagle X2 software. It should be appreciated that any other software may also be used for pattern recognition and case-based reasoning, as per the models developed by the centralized data collection center. Specifically, the collection of data over a set period can be used to predict future system performance and requirements. The command center 110 also provides an option for synchronizing recorded events to a central time clock. This could be advantageous for analyzing the oil well 102 to find correlations between various down hole parameters and for forensic analysis of subsystem failures. For example, a series of data obtained from the well site would provide a true sequence of events prior to an event failure (such as a subsystem failure) at the well site. Additionally, information obtained from the well site also serves as a quality check measurement for future well site developments.

The system 100 further includes an input device 120. The input device 120 is configured to accept an input and control the functions of the system 100. The input device 120 is communicatively coupled to the command center 110 for receiving the input from the user. The input device 120 is configured to be operated on computers, tablets as well as mobile phone applications, personal electronic devices and the like. According to an embodiment of the present invention, all units used in system 100 are equipped with a touch screen display for facilitating real time viewing monitoring.

The system 100 further includes an output device 122. The output device 122 is communicatively coupled to the command center 110. The command center 110 transmits the output signal to the output device 122 via the plurality of transmitters 108. The output device 122 is configured to generate a comprehensive analysis and log report in PDF and Excel formats based on the output signal received from the command center 110. The output device 122 also generates a detailed cost report that represents the operational cost of the entire process of optimization of the completion fluid by the DAS 100. The reports generated can vary according to the input provided to the system 100, based on the output desired by the user. The user can access the output device 122 remotely from any location. The output device 122 further enables the user to remotely view the entire process of optimization of the completion fluid in real time. The input and output devices (120 and 122) are communicatively coupled or connected to a Wi-Fi or satellite transmitter/receiver (not shown) for communicating information to the user. The output device 122 serves to transmit data. Data is differentiated between input and output and the completion chemical is adjusted based on the readings of the sensors. The output side of the mixing plant is designed to mimic bottom hole (of the well) actions.

The system 100 further includes one or more Deutz diesel powered engines (trademark of Deutz) for facilitating the process of optimization of the completion fluid. A belt-driven and hydraulic compressor control system coupled with the aforementioned engines provides an AC generator, a welder, a booster, a battery charger and a hydraulic capability through an integrated SAE ‘A’ power-take off port (PTO) port.

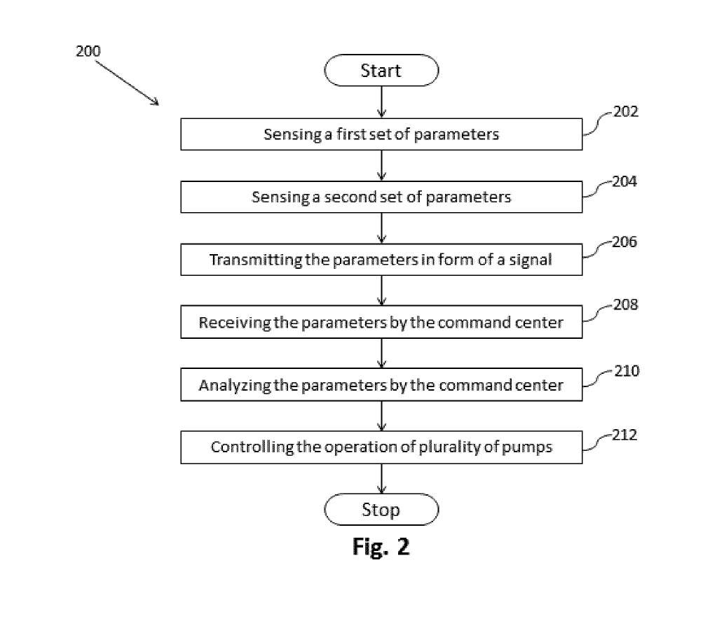

A method 200 for optimizing a composition of a completion fluid entering in the oil well 102 is shown in the flowchart of FIG. 2. At step 202, the first set of sensors 104 sense one or more parameters of the completion fluid. The one or more parameters include one or more of a fluid flow rate, a temperature, a viscosity, and a pH of the completion fluid. At step 204, the second set of sensors 106 sense one or more parameters associated with the oil well, as explained in conjunction with FIG. 1. The parameters include, but are not limited to, oil well head pressure, temperature and pressure inside the oil well, porosity of the bed, and the like. At step 206, the aforementioned parameters sensed by the first and second set of sensors (104 and 106) are transmitted by way of the transmitters 108. At step 208, the transmitted data is received at the command center 110. At step 210, the command center 110 analyzes the data and determines the first ratio which is the ratio in which the chemicals are to be blended to maintain the optimized composition of the completion fluid. Finally, at step 212, the command center 110 sends a signal to control the operation of the pumps 112. The pumps 112 are controlled in such a way that the chemicals are mixed in the first ratio to form the completion fluid.

In an embodiment of the present invention, the DAS 100 also involves the calculation of Buoyancy (F_{buoyancy}), Drag Force (F_{drag}) and force due to weight (F_{weight}). These forces are governed by the following equations:

F_{buoyancy}+F_{drag}>F_{weight:}

wherein,

F_{weight}=ρ_{c}*V*g

F_{buoyancy}=ρ_{f}*V*g

F_{drag}=C_{D}*(½)*A*ρ_{f}*U²

Re(Reynold's Number)=(ρ_{f}*U*D)/μ

### Whereas;

ρ_{c}=density of cuttings particles;
ρ_{f}=density of fluid;
U=fluid velocity;
D=particle diameter;
μ=fluid viscosity;
A=particle frontal area;
g=gravitational acceleration;
V=particle volume;
m=particle mass; and
C_{D}=drag coefficient.

The command center 110 includes the above calculation for analyzing the various parameters of the completion fluid and the oil well 102. These forces and calculations help in the understanding of the skip velocities for vertical clean outs. As fluid flows around a sphere, it exerts three forces in addition to gravity (i.e., buoyancy, form drag, friction). These forces must be considered in the consideration of the optimization of the completion fluids. It has been found that:

Static force=buoyuant force

Kinetic force=form drag+friction sphere drag

The optimization of the completion fluid using the DAS 100 is explained by using the following example.

### EXAMPLE

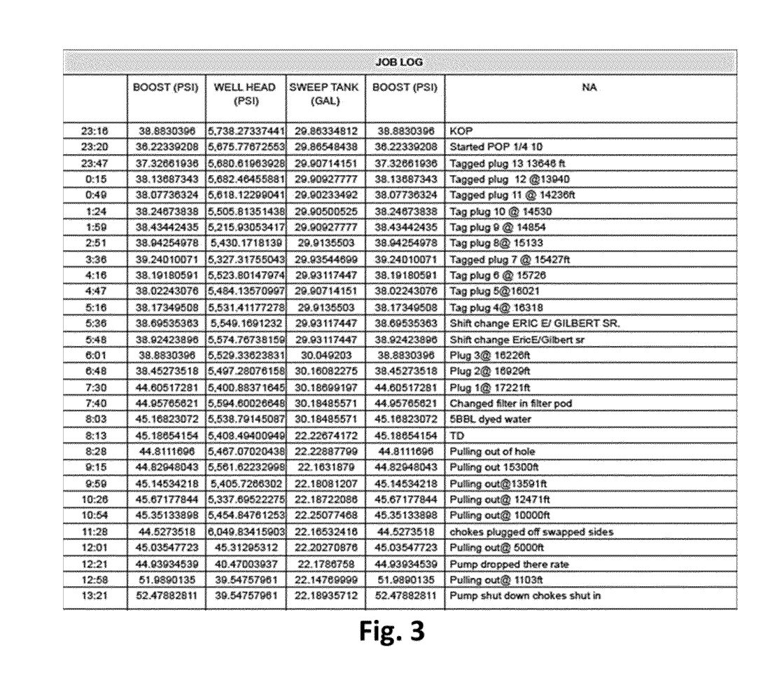

At the well site, the following well parameters were periodically monitored and recorded. The parameters of the completion fluid, such as temperature, pH, drag, viscosity, ratio of chemicals to be blended to form the completion fluid (FR, POP and slick water) and the like were sensed by the first set of sensors 104. The parameters associated with oil well 102, such as well head pressure, depth of the hole, porosity of the mud and the like were sensed by the second set of sensors 106. The parameters were transmitted to the command center 110 and based on the information given to the command center 110, the ratio of chemicals that were to be blended to form the completion fluid i.e., gel and slick water were adjusted accordingly. The periodic change in all the parameters was recorded in real time and a job log report was prepared by the output device 122 as shown in FIG. 3. E.g., at 23:16 the boost (PSI) i.e., the pressure at which the completion fluid is charged to the oil well 102 was 38.8830396 psi. At the same time the well head pressure of the oil well 102 was 5,738.27337441 psi and the volume of fluid in the mixing tank 116 was 29.86334812 gallons. All parameters were constantly being recorded periodically till the end of the process i.e., up till 13:21 as shown in FIG. 3.

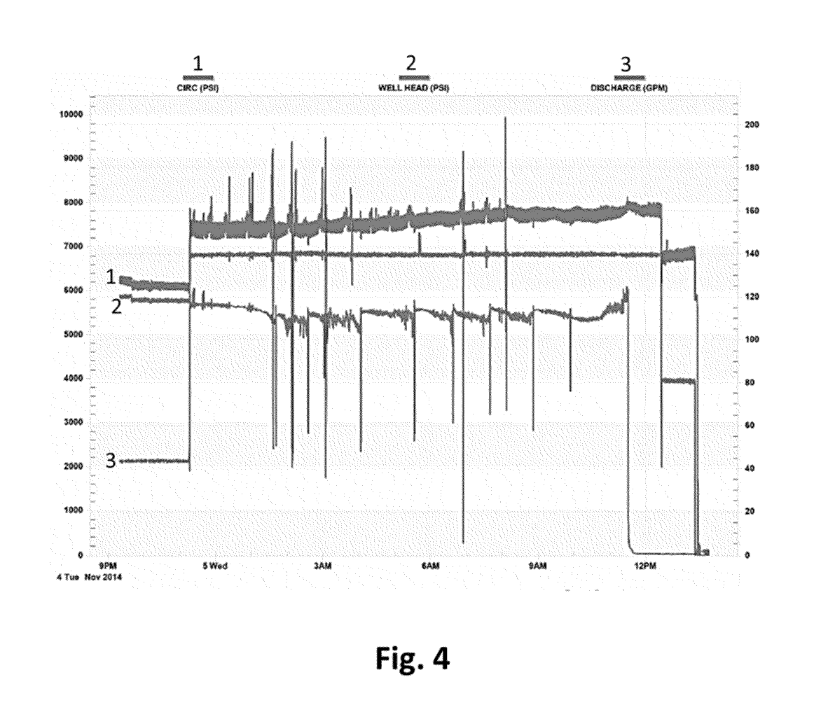

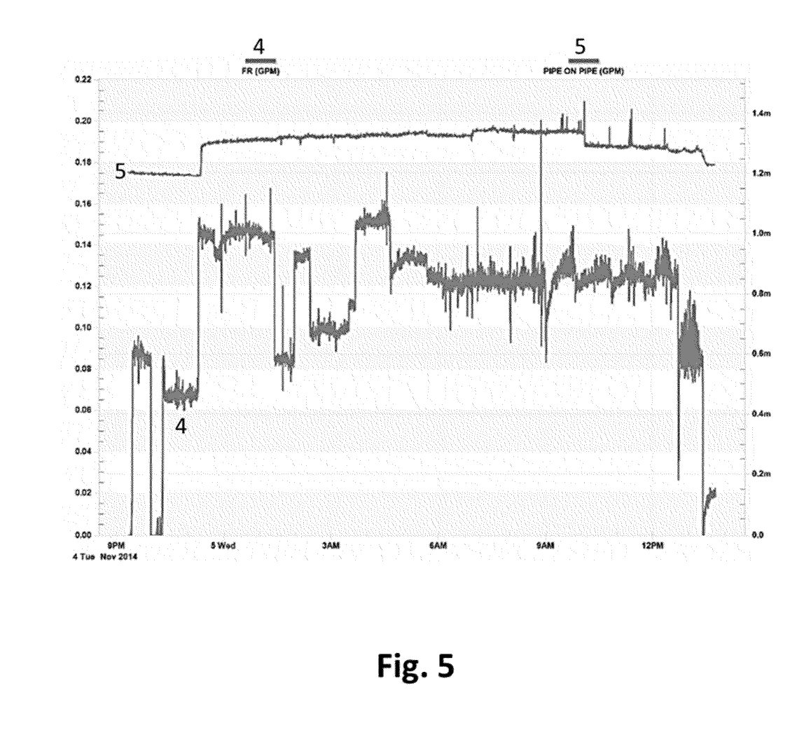

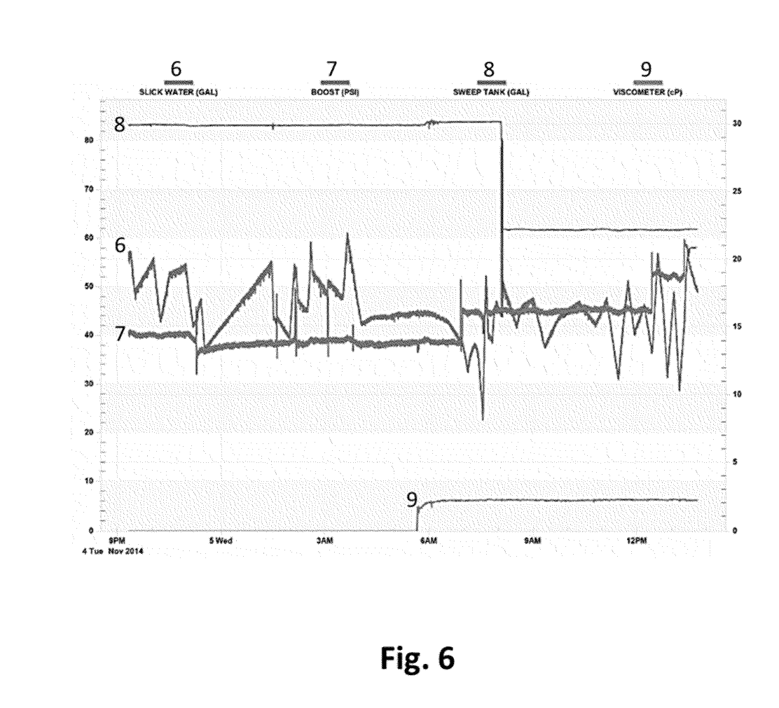

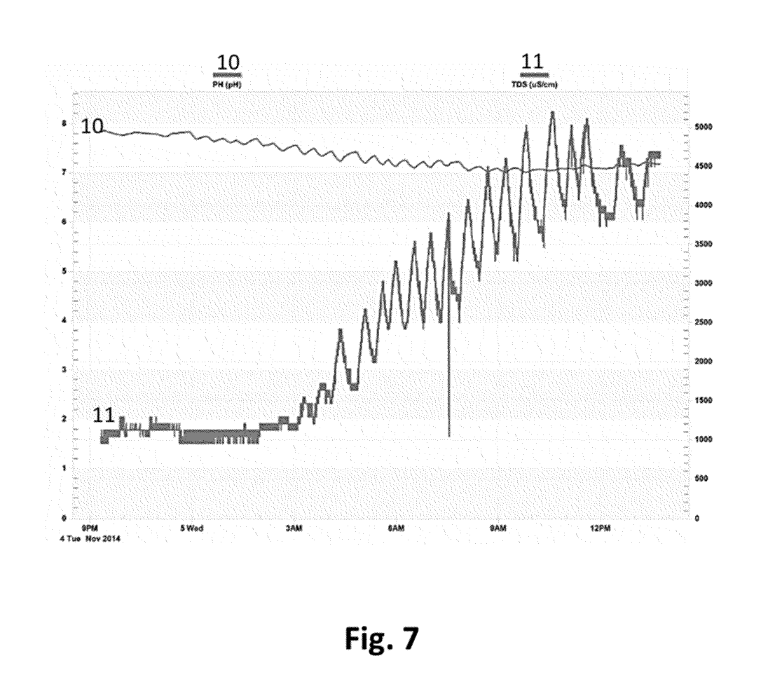

The output device 122 further generated graphs/charts based on the recorded parameters that were recorded throughout the course of the process as shown in FIG. 4-FIG. 7. The plot of various parameters associated with the completion fluid and the oil well 102 are numbered corresponding to the legends provided. The desired parameters at different time intervals were plotted and based on the periodic fluctuations in the parameters that can be seen from the graph, the onsite operator makes appropriate process control decisions. The job log reports and the graphs can be remotely communicated to the user as discussed above in the disclosure.

It can be seen from FIG. 4-FIG. 7 that throughout the course of the process, the rate of change of the volume of the slick water, the discharge rate of FR and the discharge rate of POP lubricant are reflected by the changes in the parameters associated with the completion fluid and the oil well 102. It can be concluded that, the data acquisition system 100 automatically monitors the chemicals and formulates them in the desired ratio at any particular time instant, thereby optimizing the formation of the completion fluid.

The present invention has been described herein with reference to a particular embodiment for a particular application. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claims.

What is claimed is:

1. A system for optimizing a composition of a completion fluid for an oil well in real time, the system comprising:
at least two storage tanks for respectively storing at least two chemicals that make up the completion fluid;
a mixing tank for formulating the at least two chemicals received from the at least two storage tanks;
a first set of sensors for sensing a first set of parameters of the completion fluid, wherein the first set of sensors are provided at an outlet of the mixing tank;
a second set of sensors for sensing a second set of parameters of the oil well, wherein the second set of sensors are provided at an inlet of the oil well;
at least two transmitters communicatively coupled to the first and second set of sensors, wherein the at least two transmitters are configured to transmit the first and the second set of parameters of the completion fluid and the oil well respectively in the form of a first signal in real time;
a command center for receiving the first signal from the at least two transmitters, wherein the command center is configured to analyze the first and the second set of parameters to determine a percentage composition of the at least two chemicals that are to be formulated to make up the completion fluid, wherein the command center generates a second signal associated with the percentage composition of the at least two chemicals; and
at least two pumps fluidly coupled with the at least two storage tanks, wherein the at least two pumps are configured to control a supply of the at least two chemicals to the mixing tank, wherein the at least two pumps are controlled by the second signal such that the at least two pumps supply the at least two chemicals to the mixing tank according to the percentage composition determined by the command center so as to modify the composition of the completion fluid in accordance with the first and the second signals.

2. The system of claim 1 further comprising an input device communicatively coupled to the command center for receiving an input from a user.

3. The system of claim 1 further comprising an output device, wherein the output device is communicatively coupled to the command center, and wherein the output device is configured to receive a third signal from the command center for generating a report based on the analysis of the first and the second set of parameters.

4. The system of claim 1, wherein the first set of parameters includes at least one of a fluid flow rate, a drag, a temperature, a viscosity, a pH, and a density of the completion fluid.

5. The system of claim 1, wherein the second set of parameters includes at least one of an oil well head pressure, a temperature and pressure inside the oil well, porosity of a bed, environmental parameters, directional drilling parameters, and formation evaluation parameters.

6. The system of claim 5, wherein the environmental parameters, the directional drilling parameters, and the formation evaluation parameters include at least one of a down hole pressure, a down hole temperature, a resistivity and conductivity of drilling mud and earth formations, a density and porosity of the earth formations, and an orientation of the oil well.

7. The system of claim 1, wherein the mixing tank comprises an open roof tank for facilitating visual inspection of the formulation of the at least two chemicals.

8. A data acquisition system for an oil well, the system comprising:
a first set of sensors for sensing a first set of parameters of a completion fluid, wherein the first set of sensors are present at an outlet of a mixing tank;
a second set of sensors for sensing a second set of parameters of the oil well, wherein the second set of sensors are present at an inlet of the oil well;
at least two transmitters configured to transmit the first and the second set of parameters of the completion fluid and the oil well respectively in the form of a first signal in real time;
a command center for receiving the first signal from the at least two transmitters, wherein the command center is configured to optimize a composition of the completion fluid by analyzing the first and the second set of parameters to determine a percentage composition of at least two chemicals that are to be formulated to make up the completion fluid, wherein the command center generates a second signal associated with the percentage composition of the at least two chemicals; and
at least two pumps fluidly coupled with the at least two storage tanks, wherein the at least two pumps are configured to control a supply of the at least two chemicals into a mixing tank, wherein the at least two pumps are controlled by the second signal such that the at least two pumps supply the at least two chemicals to the mixing tank according to the percentage composition determined by the command center so as to modify the composition of the completion fluid in accordance with the first and the second signals.

9. The system of claim 8 further comprising an input device communicatively coupled to the command center for receiving an input from a user.

10. The system of claim 8 further comprising an output device, wherein the output device is communicatively coupled to the command center, and wherein the output device is configured to receive a third signal from the command center for generating a report based on the analysis of the first and the second set of parameters.

11. The system of claim 8, wherein the first set of parameters includes at least one of a fluid flow rate, a drag, a temperature, a viscosity, a pH, and a density.

12. The system of claim 8, wherein the second set of parameters includes at least one of an oil well head pressure, a temperature and pressure inside the oil well, a porosity of a bed, environmental parameters, directional drilling parameters, and formation evaluation parameters.

13. The system of claim 12, wherein the environmental parameters, the directional drilling parameters, and the formation evaluation parameters include at least one of a down hole pressure, a down hole temperature, a resistivity and conductivity of drilling mud and earth formations, a density and porosity of the earth formations, and an orientation of the oil well.

14. The system of claim 8, wherein the at least two chemicals are stored in at least three storage tanks.

15. The system of claim 8, wherein the mixing tank facilitates the formulation of the at least two chemicals to form the completion fluid.

16. The system of claim 8, wherein the mixing tank is an open roof tank such that the open roof facilitates visual inspection of the mixing of the at least two chemicals.

17. A method for optimizing a composition of a completion fluid entering in an oil well, the method comprising:
sensing a first set of parameters of the completion fluid using a first set of sensors, wherein the first set of sensors are provided at an outlet of a mixing tank;
sensing a second set of parameters of the oil well using a second set of sensors, wherein the second set of sensors are provided at an inlet of the oil well;
transmitting the first and the second set of parameters sensed by the first and the second set of sensors in the form a first signal using at least two transmitters;
receiving the first signal at a command center;
analyzing the first and the second parameters at the command center and determining a percentage composition of at least two chemicals that form the completion fluid, wherein the command center generates a second signal associated with the percentage composition of the at least two chemicals; and
controlling an operation of at least two pumps by the command center based on the second signal so as to optimize the composition of the completion fluid as needed in the oil well.

18. The method of claim 17, wherein the operation of the at least two pumps is controlled by the second signal, such that the at least two pumps supply the at least two chemicals to the mixing tank according to the percentage composition determined by the command center.

19. The method of claim 17 further comprising an input device communicatively coupled to the command center for receiving an input from a user.

20. The method of claim 17 further comprising an output device, wherein the output device is communicatively coupled to the command center, wherein the output device is configured to receive a third signal from the command center for generating a report based on the analysis of the first and the second set of parameters.

21. The method of claim 17, wherein the first set of parameters include at least one of a fluid flow rate, a drag, a temperature, a viscosity, a pH, and a density.

22. The method of claim 17, wherein the second set of parameters include at least one of an oil well head pressure, a temperature and pressure inside the oil well, porosity of a bed, environmental parameters, directional drilling parameters, and formation evaluation parameters.

23. The method of claim 22, wherein the environmental parameters, the directional drilling parameters, and the formation evaluation parameters include at least one of a down hole pressure, a down hole temperature, a resistivity and conductivity of drilling mud and earth formations, a density and porosity of the earth formations, and an orientation of the oil well.
